(19) United States
(12) Patent Application Publication
(10) Pub. No.: US 2021/0342783 A1
(43) Pub. Date: Nov. 4, 2021

(54) SYSTEM AND METHOD OF AUTOMATED EXTRACTION AND VISUALIZATION OF KNOWLEDGE ABOUT ENTERPRISE TECHNOLOGY, PERSONNEL AND BUSINESS FUNCTIONS

(71) Applicant: OPTUM, INC., Minnetonka, MN (US)

(72) Inventors: Somadev PASALA, Montclair, NJ (US); Sreedhar POTTURI, Bridgewater, NJ (US); Patrick HAFFORD, Washington, NJ (US)

(21) Appl. No.: 16/325,818

(22) PCT Filed: Aug. 16, 2017
(86) PCT No.: PCT/US17/47120

§ 371 Date: Feb. 15, 2019

Related U.S. Application Data
(60) Provisional application No. 62/376,614, filed on Aug. 18, 2016.

(51) Int. Cl. G06Q 10/10; G06Q 10/06; G06F 16/953

(52) U.S. Cl. CPC G06Q 10/10; G06F 16/953; G06Q 10/0639

(57) ABSTRACT

A method of improving the performance of an information computer system for an enterprise includes cataloging information artifacts from the information computer system. The information artifacts represent data about intellectual assets and interrelationships between intellectual assets within the enterprise. Knowledge maps are created representing the cataloged information artifacts within a knowledgebase. A knowledge map relevant to a user is identified. The identified knowledge map is displayed to the user via an output.

### FIELD OF THE INVENTION

The subject disclosure relates to enterprise knowledge bases and more particularly to automatically discovering information related to technology, people, and business function within an enterprise and graphical relationships between them.

### BACKGROUND OF THE INVENTION

Enterprises have a lot of tacit knowledge about business, technology, and business functions that is spread throughout their business. This includes knowledge regarding various business functions including the knowledge of the users who use certain business technology about the capabilities provided by those technologies. The knowledge might be about be about the technology itself or business functions where such intellectual assets (or entities) are applied, or it could be about the personnel who use these intellectual assets to serve a business function. The knowledge might be about the mutual relationships between intellectual assets, its use, and/or the personnel who use the intellectual assets.

Such enterprise knowledge is hard to accurately catalog and maintain in a useful way. An enterprise is a dynamic entity where its intellectual assets, personnel, and business functions are under great flux. Any manual process which attempts to catalog this knowledge has to be repeated at a rate matching the enterprise changes in order to keep the information catalog up to date and accurate. This causes building and maintenance of repositories of knowledge or information catalogs which is a costly process and also involves the risk of obsolescence. While some computer systems may catalog such knowledge, they are limited to a specific type of technology, process, or personnel related information. This results in a fragmented view of enterprise relationships.

### SUMMARY OF THE INVENTION

In light of the needs described above, in at least one aspect, there is a need for a continuous system in which enterprise data is effectively catalogued, easily retrievable, and automatically updated.

The subject technology provides a system and method which allows enterprise data to be cataloged, mapped, searched, and visualized, in an efficient and practical way that presents a unified view of enterprise data. Further, the subject technology allows the data and related maps to be accessible for easy updating. Finally, the subject technology can be implemented automatically, such as continuously or at fixed time intervals, keeping data up to date.

In some embodiments, the subject technology relates to a method of improving the performance of an enterprise information computer system comprised of a plurality of elements representing the information contained with the system. The method includes automatically scanning a plurality of information sources of the enterprise information computer system to identify information artifacts in the information sources that describe one or more interrelationships between the elements. A unique resource identifier (URI) is assigned to each of the identified information artifacts. Each of the information artifacts is moved to a storage location based on its assigned URI. The information artifacts are programmatically scanned in the storage location by at least one parser to extract facts descriptive of at least one of the following: the elements; and the interrelationships. A plurality of knowledge maps are automatically generated that describe at least one of the following based on the extracted facts: the elements; and the interrelationships. A visualization of at least one of the knowledge maps on is shown on a display. In some cases, the interrelationships are automatically analyzed and at least one of the interrelationships is identified as inefficient based on at least one of the knowledge maps. The enterprise information computer system is then updated in a manner that changes each of the identified inefficient interrelationships.

In some embodiments, the subject technology relates to a method of improving the performance of an information computer system for an enterprise. The method includes cataloging information artifacts from the information computer system, the information artifacts representing data about intellectual assets and interrelationships between intellectual assets within the enterprise. The information artifacts can relate to at least the following intellectual assets: computer code, configuration information, structured information sources, and unstructured information sources. Knowledge maps are created representing the cataloged information artifacts within a knowledgebase. When creating knowledge maps, the knowledge maps graph can interrelationships between people, business functions, and technology within the enterprise. A knowledge map relevant to a user is identified. The identified knowledge map is displayed to the user via an output. The step of cataloging information artifacts can further include scanning a plurality of data elements within information sources of the information computer system. A URI can then be assigned to each information artifact, the information artifacts being added to a designated area within a storage location based on the assigned URI, each information artifact in the storage location sharing at least one interrelationship with the other information artifacts within the designated area. The URIs can also be organized within a searchable index such that the user can search the URIs to retrieve and modify information artifacts within the storage location. In some cases, creating the knowledge maps includes programmatically scanning the information artifacts in the storage location by at least one parser to extract facts descriptive of the corresponding intellectual asset.

In some embodiments, each intellectual asset is analyzed with respect to other intellectual assets to determine interrelationships between the intellectual assets, the information artifacts within a knowledge map corresponding to intellectual assets with shared interrelationships. The method can further include providing a search function allowing the user to identify and access the cataloged information artifacts. In some cases, the method includes using the search function, by the user, to find cataloged information artifacts and grouping the information artifacts, by the user, within the knowledge maps.

In some embodiments, an input is provided to allow the user to modify the knowledgebase. The knowledgebase is accessed via the input, by the user, to create new intellectual assets within the knowledgebase. The user can also access the knowledgebase via the input, to modify knowledge maps within the knowledgebase. In some embodiments, a platform is provided to allow the user to enter feedback regarding the displayed knowledge map. The displayed knowledge map is modified based on the feedback from the user. The platform can display a list of interrelationships between information artifacts within the displayed knowledge map, the user entering feedback by entering a plurality of numbers representing the strength or weakness of interrelationships between the information artifacts within the displayed knowledge map. Modifying the displayed knowledge map can include removing at least one information artifact from the displayed knowledge map that has a weak interrelationship with other information artifacts within the displayed knowledge map.

In some embodiments, the method further includes providing an interface for the user, the interface including the output, wherein the interface is configured to allow users to quickly search through the knowledgebase to discover and visualize underlying knowledge maps. Further, in some embodiments, the identified knowledge map is processed into a digestible format before it is displayed to the user.

### BRIEF DESCRIPTION OF THE DRAWINGS

So that those having ordinary skill in the art to which the disclosed system pertains will more readily understand how to make and use the same, reference may be had to the following drawings.

FIG. 1 is a high level block diagram of a method in accordance with the subject technology.

FIG. 2 is a block diagram of the cataloging phase of a method in accordance with the subject technology.

FIG. 3 is a block diagram of the mapping phase of a method in accordance with the subject technology.

FIG. 4 is a block diagram of the output phase of a method in accordance with the subject technology.

FIG. 5 is a block diagram of a feedback phase of a method in accordance with the subject technology.

FIG. 6 is a block diagram showing examples of a method in accordance with the subject technology.

### DETAILED DESCRIPTION

The subject technology overcomes many of the prior art problems associated with knowledge source limitations, knowledge base refresh and retrieval speed, and efficiency. The advantages, and other features of the systems and methods disclosed herein, will become more readily apparent to those having ordinary skill in the art from the following detailed description of certain preferred embodiments taken in conjunction with the drawings which set forth representative embodiments of the present invention. Like reference numerals are used herein to denote like parts.

In brief summary, the subject technology provides a system and method that automatically and continuously identifies, catalogs, and graphs data related to intellectual assets (or entities) within an enterprise and allows for easy and practical data manipulation, retrieval, and review. Enterprises (or business entities) often tend to accumulate numerous intellectual assets. Using software as an example, an enterprise might build custom software in-house, purchase software from an outside source, or gain new software through an acquisition of another company. The subject technology helps build knowledgebase which includes the otherwise tacit knowledge about this software of subject matter experts for convenient retrieval, the knowledgebase updating automatically over time. This allows for an understanding of the interdependencies between the technology and its users and the business functions they serve, empowering decision makers to rely on information retrieved from the knowledgebase to make informed decisions. Notably, while software is used as an example above, the subject technology is applicable to numerous and varied intellectual assets within a business, as discussed in more detail herein.

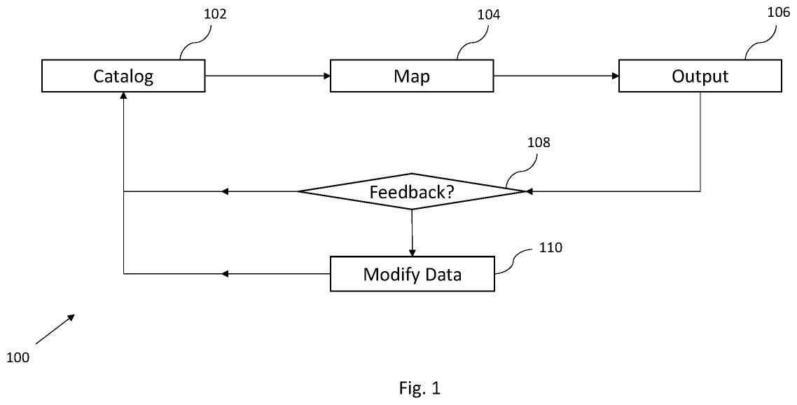

Referring now to FIG. 1, block diagram of a method in accordance with the subject technology is shown generally at 100. Notably, the block diagram of FIG. 1 represents only a high level description of the subject technology and the various components depicted therein are described in more detail with respect to the other figures shown and described herein. The method 100 can be carried out on a system with components as discussed herein, such as processors, analytics modules, data storage locations, input and output devices, and the like.

The method 100 includes the following three major processing phases: a cataloging phase 102; a mapping phase 104; and an output phase 106. In the cataloging phase 102, there is an ingestion of data from information sources within the business entity, the data being added to a storage location. At the mapping phase 104, knowledge is mapped, or graphed, and interdependencies and/or interrelationships between the data are identified for coherent storage and retrieval. At the output phase 106, the mapped data is navigated and retrieved for presentation to a user such that the user can review the data and possibly discover relationships of interest between various pieces of data.

In some cases, after the output phase 106, the method 100 can also involve a feedback stage 108. In the feedback stage 108, the user provides input regarding the data interdependencies/interrelationships identified by the system and the effectiveness of the knowledge map. The data can then be optionally modified at modify data block 110 to reflect the user's feedback before further cataloging. Modification of the data can also include annotating or building on top of underlying catalogued data without actually changing the underlying data. For example, the data can be annotated using text, voice, or video input to modify metadata associated with the underlying data.

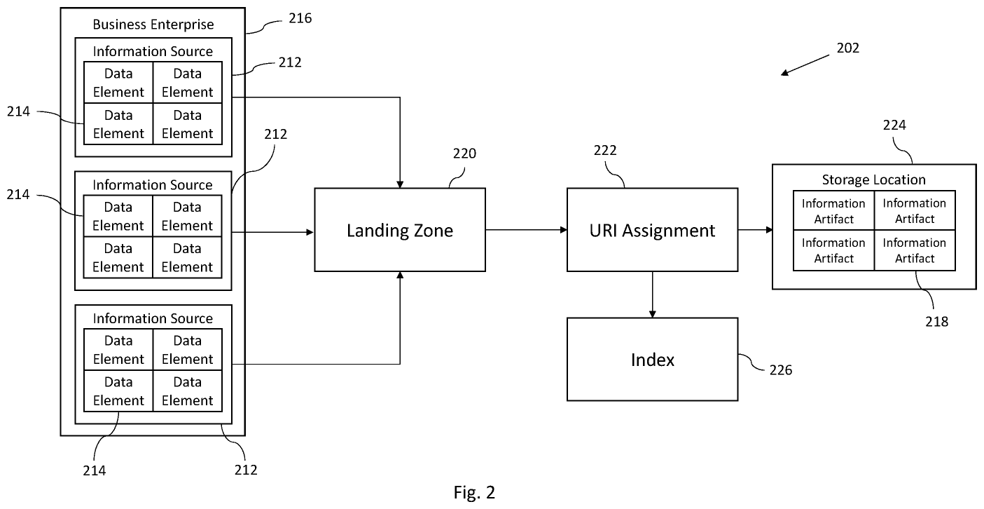

Referring now to FIG. 2, a block diagram of the cataloging phase is shown generally at 202. During the cataloging phase 202, information is ingested into the system. Ingestion of data from the information sources 212 can be done automatically by a processor, digital chip, ASIC, or the like within the overall system. In some cases, the cataloging phase 202 is done continuously such that a new cataloging phase begins immediately after the previous cataloging phase 202 has been carried out, or immediately after a cycle of the other phases of the system has been complete. In other cases, the cataloging phase 202 repeats periodically to conserve system resources, such as every few minutes, every hour, every day, every week, or at some other set time interval.

The information being cataloged comes from information sources 212 within a business enterprise 216. The information sources 212 can include any location within the business enterprise 216 within which information relevant about the various intellectual assets of the business enterprise 216 are stored. For example, software, reports, or property files are all areas of a business enterprise 216 which might include information sources 212 which can be scanned for information. However, this is by no means an exhaustive list. Data elements 214 within the information sources 212 are then scanned and relevant information is extracted from the various information sources 212 for storage as information artifacts 218. Data elements 214 might include metadata from one of the information sources 212 related to the function or purpose of that information source 212. Various examples of types of information artifacts 218 include configuration information, structured information, or computer code. Configuration information changes a systems behavior, grants access to a system, or associates a person as a user of a system, to give a few examples. Structured Information includes any report or data extract which has a predefined structure and means or agreed upon convention to interpret data elements 214, such as reports from HR systems, security systems, and finance systems for example. As relevant data elements 214 are identified, information artifacts 218 are then held within the landing zone 220. The landing zone 220 serves as a temporary storage location where preprocessing, such as decompression and identification of incoming information type and source, can be carried out.

From the landing zone 220, unique resource identifiers (“URIs”) are assigned to each of the information artifacts 218 at URI assignment block 222. Based on the assigned URI, each information artifact 218 is then moved to a particular area within a storage location 224. The URI tags are also stored within a persistent catalog in index block 226. Since the URIs provide a unique name for each entity discovered and identifies an information artifact 218 being referred to, a map or URI within the index 226 can be created. This allows for searching and referencing of URIs. Further, this allows for a constant time retrieval algorithms to be implemented.

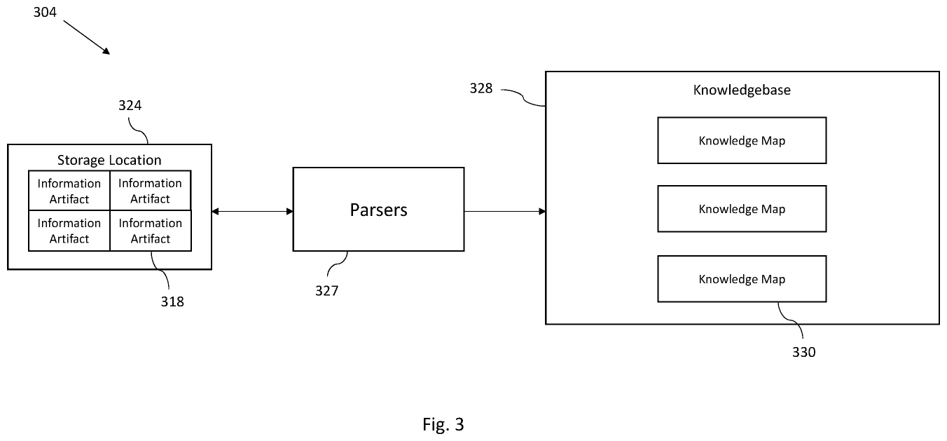

Referring now to FIG. 3, a block diagram of the knowledge phase is shown generally at 304. The knowledge phase 304 typically follows the preprocessing and indexing of information artifacts 318 in the cataloging stage 102. In general, during the knowledge phase 304, knowledge is extracted from the stored information artifacts 318 to build a coherent map of the underlying data.

A series of parsers 327 are programmed to scan the information artifacts 318 to extract relevant information about the intellectual assets, the relationships between the intellectual assets, and metadata regarding how the intellectual assets relate to one another. The parsers 327 specifically target sets of information artifacts 318 to selectively draw information from the storage location 324. The parsers 327 rely on a parsing frameworks that understands, and helps group data according to, a class of information sources like source code, configuration, reports, or the like. The parsers 327 are index 226 and knowledgebase 328 aware and scan through information sources 212 (or information within storage location 224) and identify and process context and type. The new data reviewed by the parsers to identify and process context so the new information can be combined with the current knowledgebase 328 and index 226. To that end, new parser information is combined with the information artifacts 318 to be compiled and saved within a knowledgebase 328. For example, the parsers review the data elements 214 of the information artifacts 318, in conjunction with the context information that can be deduced from information source 212, already existing index 226 data and current knowledge in knowledgebase 328, to determine: if a new entity should be added to knowledgebase 328; if new metadata should be added to entities currently in knowledgebase 328; if new relationships can be established between entities; and if new metadata should be added to relationships already established in knowledgebase 328. In some cases, new parser information can also be created by retrieving information from the knowledgebase 328 and deducing further facts, or applying further analytics, to create new parser information which can then be transferred to the knowledgebase 328.

Additionally, the parsers 327 recognize changes and/or updates to previously cataloged information artifacts 318. For example, if software within the business was updated to a more recent version then during the cataloging phase 202, the previously stored information artifact 218 associated with that software would be updated. As a result, during the knowledge phase 304, the parsers 327 would review the stored information artifact 318 and recognize that it was modified from the previous version. Therefore, rather than absorb that particular information artifact 318 again, the parsers 327 would only absorb information related to the changes made to the previous information artifact 318. These changes can then be depicted, for example, as metadata associated with the intellectual asset related to that particular information artifact 318. Similarly, the parsers 327 can recognize when an information artifact 318 is the same as a previously recognized information artifact 318, and therefore, no additional action needs to be taken for that information artifact 318 within the knowledge phase.

The knowledgebase 328 acts as a data storage location within which the information can be combined in a coherent and digestible format to assemble an ontology or data map. In some cases the information can be grouped in various knowledge maps 330 within the knowledgebase 328, each knowledge map 330 including interdependent information artifacts 318. The parsers 327 are programmed such that as data is compiled in the knowledgebase 328 based on interdependencies, relevant people, business functions, and technology components are tied together within a particular knowledge map 330. For example, the knowledge maps 330 can show various entities within the enterprise as nodes with edges representing the relationships between entities. In general, the data is not ideal for human consumption when it first enters a knowledge map 330, but needs an additional conversion step to reach a more typical graph form.

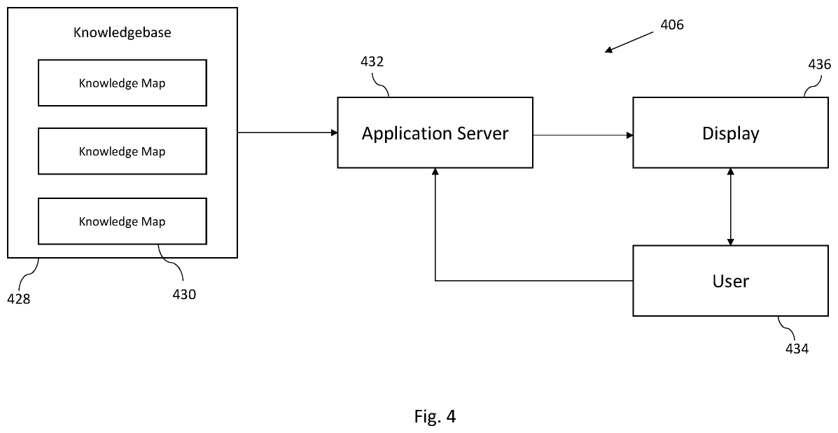

Referring now to FIG. 4, a block diagram of the output phase in accordance with the subject technology is shown generally at 406. During the output phase 406, the mapped data is presented to a user 434 via a display 436 for consumption. An application server 432 interfaces with the knowledgebase 428 from the mapping stage 304. The user 434 can interface with the display 436, for example via a processor and keyboard. Alternatively, the user 434 might communicate directly with the application server 432. In either case, the display 436 then interfaces with the application server 432, which draws the required information from the knowledgebase 428. For example, if the user 434 is ordering a product which is sold by the business enterprise, a particular knowledge map 430 will likely link all of the intellectual assets that have some interdependency with that product, or to sales of the product. This could include data regarding various models of that product, current inventory, suppliers, length of delay in receiving new products from various suppliers after an order is placed, or costs, just to name a few examples. Therefore, rather than the user having to search the entire enterprise, all information relevant to the product is presented to the user 434 simply by the user 434 providing the name of the product to the display 436 or application server 432.

By way of example, a business leader might like to assess the impact that changing, or adding new processes or capabilities in their company would have. The business leader can then use the display 436 (or other input device) to query the knowledge base 428 about that technology or area of technology. The business leader will be presented with an output that shows the impact of the change in terms of cost and disruption on people, processes, or software assets within the enterprise. Further, area of interest for that business leader will be identified and refined automatically as the business leader continues to use the system. This can improve the relevancy of information presented to the business leader, or even identify new areas of interest.

After the user 434 has reviewed data during the output phase 406, there may be a desire to rate, or otherwise comment on the relevancy of the data that was obtained. For example, a user 434 might identify certain data that was included in the knowledge map as irrelevant, while other data is rated as of high importance. Similarly, the user 434 might identify other data (i.e. data regarding information artifacts or intellectual assets) which the output phase 406 failed to display which has a strong interrelationship with the data they viewed. Therefore, the system may benefit from the user participating in a feedback phase 108 after the output phase 406.

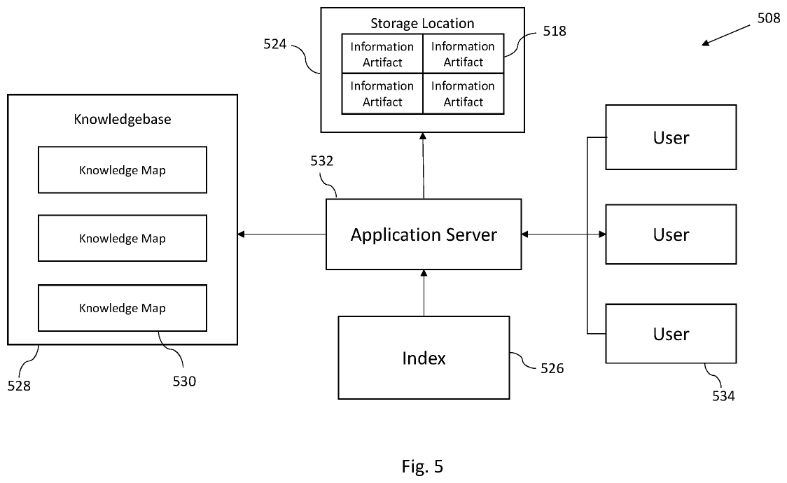

To that end, referring now to FIG. 5, a feedback phase 508 in accordance with the subject technology is shown. Here, the users 534 can provide comments, messages, or other forms of feedback to the application server 532 which can then modify the data, or groupings of data, contained in the knowledgebase 528. For example, in some cases, the users 534 can input comments and/or messages back into the system. The parsers 327 can then review the comments and messages, and modify the information within the knowledgebase 528 to ensure more relevant data is provided to the users 534. In other cases, there is an input means which interfaces with the application server 532, the input means programmed to allow the user to input data directly into a program on the application server 532. The program then analyzes and weighs the user input. For example, the program might ask a user 534 to rate the relevancy of various data which was included in the knowledge map 530 they reviewed by providing a numerical indication of relevancy. The numerical rating provided by the user will reflect the strength or weakness of interrelationships between the information artifacts within the displayed knowledge map 530. The program may also give the user 534 access to a list of headings which identify other subsets of data (e.g. a list organized by URI) which were not included in the presented knowledge map 530, such that the user 534 can select relevant data which should have been included in the knowledge map 530. After taking in feedback from a number of users (or periodically), the program within the application server 532 then accesses the knowledgebase 528 to modify the data according to the feedback. For example, the program might provide a democratized weighing of the accuracy and pertinence of all information within a knowledge map 530 based on the feedback from the users 534. Notably, the underlying data can either be modified directly or merely annotated or built on top of.

In some cases, rather than interfacing with the knowledgebase 528, the users 534 instead rely on the application server 532 to interface directly with information artifacts 518 within the storage location 524. The index 526 can provide a means to allow the user to effectively modify data within the storage location 524. The index 526 generally allows the information artifacts 518 to be efficiently searched by URI, similar to the index 126 of FIG. 2. When the user selects a URI from the index 526, they can then modify the underlying data that is associated with that URI, such as the information artifacts 518.

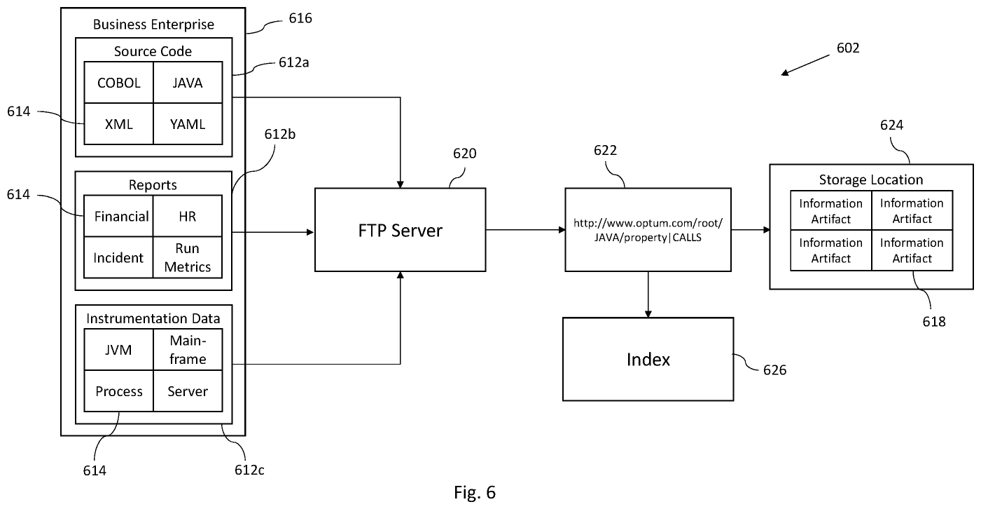

Referring now to FIG. 6, a block diagram is shown generally at 602, the block diagram 602 representing examples of how the subject technology is implemented. Notably, the diagram 602 generally mimics the diagram 202 of the cataloging phase, but provides specific examples. For example, a series of various information sources 612 within the business enterprise 616 are shown from which information is drawn. The information sources 612 within the business enterprise 616 include knowledge regarding source code, reports, and instrumentation data. Within the source code information source 612a are individual data elements 614 representing COBOL, JAVA, XML, and YAML. Data elements 614 about each of these languages will be contained within a particular area of the source code information source 612b. Likewise, the “reports” information source 612b includes data elements 614 in different areas with data on financial reports, HR reports, incident reports, and run metric reports. Finally, the information source 612c including instrumentation data includes data elements 614 on JVM, mainframe, process, and server instruments.

Data gathered from the data elements 614 in these information sources 612 is then sent to file transfer protocol server 620 which serves as a temporary storage location. Identifiers are assigned to the data elements at block 622 and they are then moved into the storage location 624 and the index 626. Depending on the information source 612 and area within that information source 612 that each data element 614 came from, the data element 614 will be incorporated into a specific information artifact 618 at a certain location within the storage location 624. This allows the data to be grouped depending on its point of origination within the business enterprise 616. Similarly, a corresponding identifier for each data element 614, or for each information artifact 618 that corresponds to that data element 614 is listed within the index 626 for easy searching and/or lookup.

It will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements (e.g., processors, storage locations, inputs and outputs, servers, and the like) shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed. cm What is claimed is:

1. A method of improving the performance of an enterprise information computer system comprised of a plurality of elements representing the information contained with the system, the method comprising:
automatically scanning a plurality of information sources of the enterprise information computer system to identify information artifacts in the information sources that describe one or more interrelationships between the elements;
assigning a unique resource identifier (URI) to each of the identified information artifacts;
moving each of the information artifacts to a storage location based on its assigned URI;
programmatically scanning the information artifacts in the storage location by at least one parser to extract facts descriptive of at least one of the following: the elements; and the interrelationships;
automatically generating a plurality of knowledge maps that describe at least one of the following based on the extracted facts: the elements; and the interrelationships; and
displaying a visualization of at least one of the knowledge maps on a display.

2. The method of claim 1, further comprising:
automatically analyzing the interrelationships and identifying at least one of the interrelationships as inefficient based on at least one of the knowledge maps; and
updating the enterprise information computer system in a manner that changes each of the identified inefficient interrelationships.

3. A method of improving the performance of an information computer system for an enterprise, the method comprising:
cataloging information artifacts from the information computer system, the information artifacts representing data about intellectual assets and interrelationships between intellectual assets within the enterprise;
creating knowledge maps representing the cataloged information artifacts within a knowledgebase;
identifying a knowledge map relevant to a user; and
displaying the identified knowledge map to the user via an output.

4. The method of claim 3 wherein the step of cataloging information artifacts includes:
scanning a plurality of data elements within information sources of the information computer system;
assigning a unique resource identifier (URI) to each information artifact, the information artifacts being added to a designated area within a storage location based on the assigned URI, each information artifact in the storage location sharing at least one interrelationship with the other information artifacts within the designated area.

5. The method of claim 4 further comprising organizing the URIs within a searchable index such that the user can search the URIs to retrieve and modify information artifacts within the storage location.

6. The method of claim 5 wherein creating the knowledge maps includes programmatically scanning the information artifacts in the storage location by at least one parser to extract facts descriptive of the corresponding intellectual asset.

7. The method of claim 3 wherein the information artifacts relate to at least the following intellectual assets: computer code, configuration information, structured information sources, and unstructured information sources.

8. The method as defined in claim 3 wherein in the step of creating knowledge maps, the knowledge maps graph interrelationships between people, business functions, and technology within the enterprise.

9. The method defined in claim 3 wherein each intellectual asset is analyzed with respect to other intellectual assets to determine interrelationships between the intellectual assets, the information artifacts within a knowledge map corresponding to intellectual assets with shared interrelationships.

10. The method defined in claim 3 further comprising providing a search function allowing the user to identify and access the cataloged information artifacts.

11. The method of claim 10 further comprising:
using the search function, by the user, to find cataloged information artifacts; and
grouping the information artifacts, by the user, within the knowledge maps.

12. The method of claim 3 further comprising providing an input allowing the user to modify the knowledgebase.

13. The method of claim 10 further comprising accessing the knowledgebase via the input, by the user, to create new intellectual assets within the knowledgebase.

14. The method of claim 10 further comprising accessing the knowledgebase via the input, by the user, to modify knowledge maps within the knowledgebase.

15. The method of claim 3 further comprising:
providing a platform for allowing the user to enter feedback regarding the displayed knowledge map; and
modifying the displayed knowledge map based on the feedback from the user.

16. The method of claim 15 wherein the platform displays a list of interrelationships between information artifacts within the displayed knowledge map, the user entering feedback by entering a plurality of numbers representing the strength or weakness of interrelationships between the information artifacts within the displayed knowledge map.

17. The method of claim 15 wherein modifying the displayed knowledge map includes removing at least one information artifact from the displayed knowledge map that has a weak interrelationship with other information artifacts within the displayed knowledge map.

18. The method of claim 3 further comprising providing an interface for the user, the interface including the output, wherein the interface is configured to allow users to quickly search through the knowledgebase to discover and visualize underlying knowledge maps.

19. The method of claim 3 wherein the identified knowledge map is processed into a digestible format before it is displayed to the user.
